(19) United States
(12) Patent Application Publication
(10) Pub. No.: US 2026/0005576 A1
(43) Pub. Date: Jan. 1, 2026

(54) TUNABLE, DYNAMIC COUNTERBALANCE

(71) Applicant: MRSI Systems LLC, Tewksbury, MA (US)

(72) Inventors: Nicholas Samuel Celia, JR., Avon, MA (US); Cyriac Devasia, Nashua, NH (US)

(73) Assignee: MRSI Systems LLC, Tewksbury, MA (US)

(21) Appl. No.: 18/875,893

(22) PCT Filed: May 31, 2023
(86) PCT No.: PCT/US2023/023980

§ 371 Date: Dec. 17, 2024

Related U.S. Application Data
(60) Provisional application No. 63/353,723, filed on Jun. 20, 2022.

(51) Int. Cl. H02K 7/04; H02K 7/08; H02K 7/14

(52) U.S. Cl. CPC H02K 7/04; H02K 7/08; H02K 7/14

(57) ABSTRACT

A tunable, dynamic counterbalance suitable for use, inter alia, in a die bonding system to stabilize one or more gantries disposed thereon, the tunable, dynamic counterbalance being operatively connected to a gantry and comprising at least one counter-weight disposed in a base of the system, the gantry being configured to move opposite the counterweight, thereby stabilizing that gantry as well as any other device and/or system disposed on the die bonding system, including a second or subsequent gantry, wherein the counterbalance reduces or eliminates the need for stabilizing mass, reducing the environmental impact of the gantry and allowing such systems to be closely spaced and used on second and subsequent floors of a building, while maintaining or even providing an increase in die placement accuracy, in the exemplary and non-limiting case of a die bonding system, and/or reduction in cycle time, relative to weighted bases in common use today.

### RELATED APPLICATIONS

This application claims the benefit of Provisional Patent 63/353,723, filed Jun. 20, 2022. This application is herein incorporated by reference, in its entirety, for all purposes.

### FIELD OF THE DISCLOSURE

The disclosure relates to gantries, and more particularly, to gantry stabilization using tunable, dynamic counterbalances.

### BACKGROUND

Gantries, i.e. platforms made to carry a traveling crane or similar that are supported by towers or side frames running on parallel tracks, are used in a wide variety of applications, such as in die bonding, loading and unloading of ships in port, and railroad car loading and unloading. Where high precision placement is required, the motion of the crane or similar gantry-mounted device creates an instability in the gantry that can result in inaccurate placement, which is typically resolved by slowing the motion of the crane or similar gantry-mounted device, thereby reducing the instability and increasing placement accuracy, at the expense of speed. Alternatively, a base that the gantry or gantries is/are mounted to may also have weight added to limit the amount of instability induced, however, this increases shipping costs as well as the placement flexibility and environmental impact of the gantry, due to the increased resources used to transport the gantry and the additional material used during its manufacture.

Using die bonding as a non-limiting example, typical die bonding applications involve placing dies on substrate. This process must be completed as fast as possible to maximize productivity, however, due to the small scale of the components, placement must be done very carefully and accurately to ensure that the placed dies will function correctly and not be damaged during the bonding process. Moving rapidly, as is required to complete die bonding operations as fast as possible, induces unwanted motion in such systems and the components mounted thereon that must reduce in amplitude below a threshold value before die placement to ensure placement accuracy. This is especially true where a first gantry is combined with a second or subsequent gantry on the same system, for example a high-speed, coarse motion gantry used on the same platform as a high-precision gantry.

Current die bonding systems utilize high-mass elements disposed within a base on which the system is mounted to increase stability during periods of rapid gantry movement, however this additional mass, which can be in excess of 8,000 pounds for even a relatively compact die bonding system, requires a very strong and stable platform for support. This limits placement options, requires the use of heavy equipment to move the die bonding system, and makes such systems expensive and resource intensive to ship and difficult to relocate following initial placement, while requiring additional material used during manufacture, increasing the environmental impact of its production. For example, such systems typically cannot be located on higher floors or be closely spaced, even assuming that moving such heavy equipment to a higher floor is feasible, without compromising the structural integrity of the building in which they are located.

In short, the use of additional mass to stabilize such a system significantly increases costs and environmental impact while reducing placement flexibility, relative to a more lightweight system.

What is needed, therefore, is a more environmentally friendly and scalable stabilizing and/or damping system that can be incorporated into a gantry, such as that used in die bonding systems, that is significantly lower mass than current systems, thus allowing end-users the flexibility to expand their manufacturing space vertically and/or place such systems more closely together, increasing the efficient utilization thereof, while retaining or improving on currently-achievable cycle times.

### SUMMARY

Disclosed herein is a tunable, dynamic counterbalance suitable for use with a variety of gantry types, including those used in die bonding systems, that stabilizes the gantry and/or other gantries mounted to the same system during periods of rapid movement through the use of at least one counterbalance, the counterbalance comprising at least one weight that is configured to move substantially opposite the gantry whose motion requires stabilization.

In embodiments, the at least one weight moves linearly.

In embodiments, the gantry comprises an armature, a portion of which is disposed in a magnet, the system further comprising a second magnet comprising a static armature disposed therein and further comprising a metal bar, with the linear magnet and metal bar acting as a counterweight to the gantry, helping to cancel force impulses. In embodiments, the metal bar can be increased or reduced in mass to tune the system.

Implementations of the approach described above may include a method or process, a system or apparatus, a kit, or computer software stored on a computer-accessible medium. The details or one or more implementations are set forth in the accompanying drawings and the description below. Other features will be apparent from the description and drawings, and from the claims.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is an isometric view of a tunable, dynamic counterbalance for a dual gantry positioned on a base, in accordance with embodiments of the present disclosure;

FIG. 2 is an isometric view of a tunable, dynamic counterbalance for a gantry positioned on a base, in accordance with embodiments of the present disclosure;

FIG. 3 is an isometric view of a tunable, dynamic counterbalance for a dual gantry, in a first configuration, in accordance with embodiments of the present disclosure; and

FIG. 4 is an isometric view of a tunable, dynamic counterbalance for a dual gantry, in a second configuration, in accordance with embodiments of the present disclosure.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

Disclosed herein is a tunable, dynamic counterbalance 102 that can be used to stabilize a gantry, such as is commonly used on die bonding systems. For example, in an exemplary die bonding system, a first gantry 104, which may be a coarse “pick and place” gantry, is combined with a second gantry 106, which may be a high precision gantry. Since the first gantry 104 and the second gantry 106 are disposed on the same die bonding system, the motion of one gantry tends to induce motion in the other. This is especially problematic where high-precision placement is necessary, such as where rapid motion of one gantry induces motion in the other, especially during a die bonding operation.

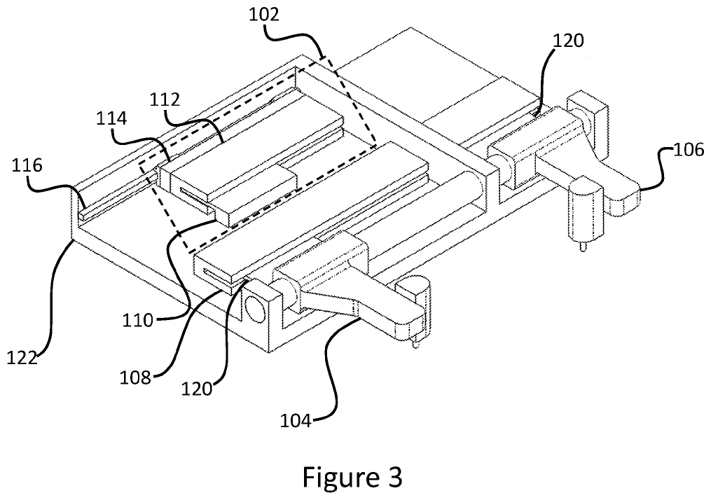

To resolve this issue without the use of a very heavy mass attached to the die bonding system, such as in a base 118 thereof, as is currently typical, and without reducing cycle times, the present disclosure teaches the use of a counterbalance 102, a portion of which is configured to travel opposite at least one gantry, in FIG. 3 the first gantry 104, although this is merely exemplary, and to thereby reduce the amount of unwanted movement in the first gantry 104 as well as any movement that may be transferred into the second gantry 106 through, for instance, the die bonding system.

In embodiments, the first gantry 104 is a coarse placement gantry, which may be configured for pick and place operations, since such gantries tend to move more rapidly and therefore induce more unwanted motion, relative to high precision gantries used for high accuracy placement, while also requiring less accuracy.

In other embodiments, the first gantry 104 and the second gantry 106 are both high-precision gantries. In such embodiments, both the first gantry 104 and the second gantry 106 may include a counterbalance 102.

In still other embodiments, however, a counterbalance 102 is attached to each gantry, only to the second gantry 106, to each of a plurality of gantries, or to some gantries and not others in a system comprising a plurality of gantries. In embodiments, the counterbalance 102 is used in a die bonding system only comprising a first gantry 104. In even further embodiments, the counterbalance 102 is used in a die bonding system 100 comprising three or more gantries. In still even further embodiments, the counterbalance 102 is used in a gantry or gantries unrelated to die bonding. In still even another embodiment, the counterbalance 102 or counterbalances 102 is/are disposed on a structure on which the system or systems comprising the gantry or gantries is disposed.

In embodiments, a portion of the counterbalance 102 is configured to travel along a linear path. In other embodiments, the counterbalance 102 comprises a rotary motor driving a tunable load connected via a belt, screw, or other fastener. In embodiments, the counterbalance 102 is configured to programmatically match a move profile of the gantry, but in an opposite direction, thereby cancelling vibrations induced in the frame 122.

Furthermore, while the Figures show the counterbalance 102 behind a gantry, the counterbalance 102 could be placed above, below, behind, or in line with the gantry without departing from the teachings of the present disclosure.

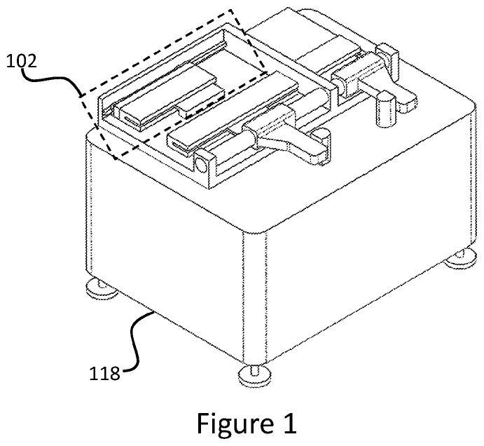

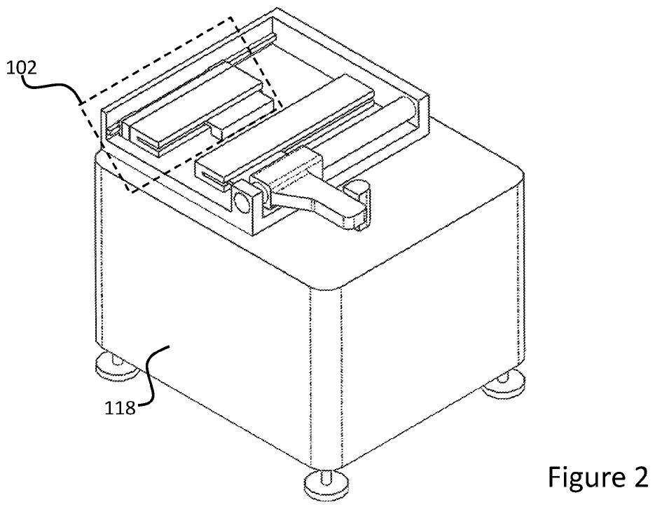

FIG. 1 shows a base 118 suitable for use with a die bonding system that further comprises a tunable, dynamic counterbalance 102 and dual gantries, in accordance with embodiments of the present disclosure. In contrast, FIG. 2 shows a base 118 suitable for use with a die bonding system 100 that further comprises a tunable, dynamic counterbalance 102 and a single gantry.

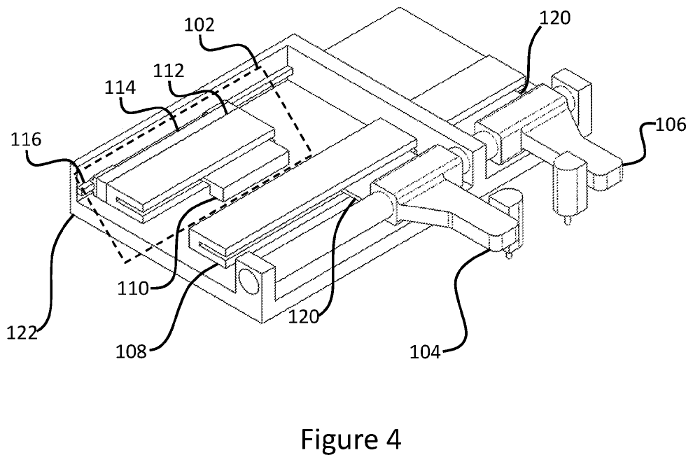

FIG. 3 provides an isometric view of a tunable, dynamic counterbalance 102 for a dual gantry system in a first configuration while FIG. 4 shows the same tunable, dynamic counterbalance 102 for a dual gantry system in a second configuration. In these embodiments, the counterbalance 102 is disposed in a frame 122 and coupled to a first gantry 104 configured to provide horizontal pick and place capabilities, the first gantry 104 being attached to an armature 120, a portion of which is disposed in a first magnet 108. The system further comprises a static armature 110, a portion of which is disposed in a second magnet 112, which is itself attached to a weight 114, which is slidingly disposed in a portion of the counterbalance 102, in embodiments utilizing a linear bearing 116, such that it can move in a direction parallel to the first gantry 104.

In embodiments, the weight 114 is a metal bar 114 and tuning the system, comprises changing the weight thereof.

In embodiments, the first and second magnets 108/112 are electromagnets that are controlled by a control system including a processor and non-transitory storage containing instructions configured to cause a portion of the counterbalance 102, such as the weight 114, to move opposite the first gantry 104 while, in other embodiments, they are permanent magnets. In still other embodiments, the magnet 112 is replaced by a weight configured to move opposite the first gantry 104, such as by mechanical connection thereto. In embodiments, no metal bar 114 is used, the magnet 112 itself being modified to be the correct weight.

More specifically regarding the first and second configurations, these show the first gantry 104 and magnet 112/metal bar 114 assemblies at the opposing limits of their travel.

While embodiments of the present disclosure have been described primarily in the context of die bonding systems, these embodiments could be used in a wide variety of gantry applications where stabilization thereof would be helpful, as would be known to one of ordinary skill in the art.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

1-20. (canceled)

21. A tunable, dynamic counterbalance for a gantry, the tunable, dynamic counterbalance comprising:
a frame;
a counterbalance disposed in the frame;
a gantry slidingly disposed in the frame,
wherein the gantry is operatively coupled to the counterbalance such that movement in the gantry induces an opposite movement in the counterbalance, and
wherein the counterbalance is configured to dynamically adjust a motion profile in real time to match and counteract motion-induced forces generated by the gantry.

22. The tunable, dynamic counterbalance of claim 1, wherein counterbalance comprises a linear, motor-driven load.

23. The tunable, dynamic counterbalance of claim 1, wherein the first gantry is coupled to a first armature, a portion of which is slidingly disposed in a first magnet.

24. The tunable, dynamic counterbalance of claim 3, further comprising a second armature, a portion of which is disposed in a second magnet, wherein either the second armature or the second magnet is fixed to the frame, wherein the other is slidingly disposed in the frame, and wherein the second armature and the second magnet are configured to provide synchronized counteracting forces to minimize torsional vibrations associated with motion of the gantry.

25. The tunable, dynamic counterbalance of claim 4, wherein the slidingly disposed component utilizes a linear bearing at the interface between the component and frame.

26. The tunable, dynamic counterbalance of claim 4, wherein the second armature is fixed to the frame.

27. The tunable, dynamic counterbalance of claim 6, wherein the first and second magnets are permanent magnets.

28. The tunable, dynamic counterbalance of claim 6, wherein the first and second magnets are electromagnets.

29. The tunable, dynamic counterbalance of claim 8, further comprising a feedback control system comprising a processor and non-transitory storage medium configured to continuously monitor the gantry's displacement and velocity and further comprising instructions configured to dynamically adjust motion of the second magnet to optimize stability of the gantry.

30. The tunable, dynamic counterbalance of claim 1 wherein the counterbalance comprises a weight that is slidingly disposed in the frame and mechanically linked to the gantry such that motion of the gantry induces opposite motion in the weight.

31. The tunable, dynamic counterbalance of claim 10, wherein the weight comprises a metal bar.

32. The tunable, dynamic counterbalance of claim 10, further comprising a linear bearing at an interface between the weight and frame.

33. The tunable, dynamic counterbalance of claim 1, wherein counterbalance comprises a rotary motor driving a tunable load connected to the rotary motor via a belt, screw, or other fastener, the load being adjustable to accommodate varying mass configurations.

34. A tunable, dynamic counterbalance for a gantry, the tunable, dynamic counterbalance comprising:
a frame;
a gantry slidingly disposed in the frame and coupled to a first armature, a portion of which is slidingly disposed in a first electromagnet;
a counterbalance comprising a second armature and a second electromagnet, wherein the second armature is fixed to the frame, a portion of the second armature is slidingly disposed in the second electromagnet, and the second electromagnet is slidingly disposed in the frame in an orientation parallel to the gantry; and
a control system comprising a processor and non-transitory storage medium comprising instructions configured to cause the processor to process an input, move the gantry in accordance with the input by energizing the first electromagnet, and move the second electromagnet opposite the first by energizing the second electromagnet.

35. The tunable, dynamic counterbalance of claim 14 wherein the second electromagnet further comprises a weight attached thereto.

36. The tunable, dynamic counterbalance of claim 15, wherein the weight comprises a metal bar.

37. The tunable, dynamic counterbalance of claim 16, further comprising a linear bearing at an interface between the second electromagnet and frame.

38. A tunable, dynamic counterbalance for a gantry, the tunable, dynamic counterbalance comprising:
a frame;
a gantry slidingly disposed in the frame;
a counterbalance comprising a weight slidingly disposed in the frame in an orientation parallel to the counterbalance; and
a mechanical linkage connecting the counterbalance to the gantry such that motion of the gantry induces opposite motion in the weight.

39. The tunable, dynamic counterbalance of claim 17, wherein the weight comprises a metal bar.

40. The tunable, dynamic counterbalance of claim 18, further comprising a linear bearing at an interface between the weight and frame.
